(19) United States
(12) Patent Application Publication
(10) Pub. No.: US 2025/0093105 A1
(43) Pub. Date: Mar. 20, 2025

(54) ELECTRIC HEATING DEVICES AND METHODS FOR KILNS OF SUBSTRATE GLASS

(71) Applicant: CAIHONG DISPLAY DEVICES CO., LTD., Xianyang (CN)

(72) Inventors: Longjiang ZHAO, Xianyang (CN); Wei YANG, Xianyang (CN); Jian XU, Xianyang (CN); Dacheng WANG, Xianyang (CN); Feng ZHANG, Xianyang (CN)

(73) Assignee: CAIHONG DISPLAY DEVICES CO., LTD., Xianyang (CN)

(21) Appl. No.: 18/969,286

(22) Filed: Dec. 5, 2024

Related U.S. Application Data
(63) Continuation-in-part of application No. PCT/CN2024/092921, filed on May 13, 2024.

(30) Foreign Application Priority Data
Sep. 4, 2023 (CN) 202311133153.9

(51) Int. Cl. F27D 11/10; F27D 19/00; F27D 21/00

(52) U.S. Cl. CPC F27D 11/10; F27D 19/00; F27D 21/0014; F27D 21/0028; F27D 2019/0006; F27D 2019/0037; F27D 2021/0007

(57) ABSTRACT

Some embodiments of the present disclosure provide electric heating devices and methods for kilns of substrate glass, relating to the field of arrangements of electric heating structures for the kilns of substrate glass. To address the problem of insufficient melting in front zones of kilns of high-generation and large-tonnage substrate glass, a heating structure combining side-stack tin oxide electrode bricks and bottom-inserted molybdenum electrodes is designed. A comprehensive thermal efficiency of the kiln is determined by introducing an appropriate amount of gas and determining an energy consumption of glass melting and a thermal energy contribution of gas and electricity under an extraction volume. This leads to a novel electric heating device for the kiln of high-generation and large-feeding substrate glass and a method thereof, effectively solving the problem of insufficient melting and unstable convection in the front zone of the kiln.

### CROSS-REFERENCE TO RELATED APPLICATIONS

This application is a Continuation-in-part of International Application No. PCT/CN2024/092921, filed on May 13, 2024, which claims priority to Chinese Patent Application No. 202311133153.9, filed on Sep. 4, 2023, the contents of each of which are hereby incorporated by reference to its entirety.

### TECHNICAL FIELD

The present disclosure relates to the field of arrangements of electric heating structures for kilns of substrate glass, and in particular, to electric heating devices and methods for kilns of substrate glass.

### BACKGROUND

At present, glass plays a crucial role as a fundamental component in display devices from the traditional color cathode ray tube industry to the current flat panel display industry. The glass serves not only as the frame and carrier of the entire display device, but also as an optical element. As upper and lower substrates of the flat panel display device, the glass must undergo fine microscopic semiconductor process(es) to meet requirements of melting capacity and convection stability of a front zone of a kiln of high-generation and large-tonnage substrate glass. During the manufacturing process of the substrate glass, glass batch materials are first fed smoothly and stably into feeding port(s) of the kiln through a feeding system, and then melted, clarified, and homogenized in the kiln to provide qualified homogeneous glass melt for subsequent process(es). The glass melt, melted in the kiln, is alkali-free high-aluminum borosilicate glass, which is primarily used for the substrate glass in the flat panel display.

As a feeding amount of the high-generation substrate glass increases, the insufficient melting capacity of the front zone of the kiln and the instability of the convection cycle of the kiln have become key problems that need to be solved urgently. The insufficient melting in the front zone of the kiln leads to defects (e.g., bubbles, stones, etc.) in substrate glass products to be generated significantly, seriously impacting production efficiency.

Therefore, it is desirable to provide electric heating devices and methods for kilns of substrate glass.

### SUMMARY

One or more embodiments of the present disclosure provide an electric heating device for a kiln of substrate glass. The electric heating device may comprise a bottom pool wall, a front pool wall, a rear pool wall, a left pool wall, a right pool wall, feeding ports, a liquid flow hole, tin oxide electrode bricks, bottom-inserted molybdenum electrodes, and a lifting adjustment mechanism. The front pool wall, the rear pool wall, the right pool wall, and the left pool wall may be disposed on the bottom pool wall, and two ends of the front pool wall may be connected to two ends of the rear pool wall through the left pool wall and the right pool wall, respectively. The feeding ports may be disposed on the front pool wall, the liquid flow hole may be disposed on the rear pool wall, the tin oxide electrode bricks may be disposed on the left pool wall and the right pool wall, and an interval between each two adjacent oxide electrode bricks among the tin oxide electrode bricks may be equal. The bottom-inserted molybdenum electrodes may be disposed on the bottom pool wall. A first portion of the tin oxide electrode bricks on the left pool wall may protrude outward from an outer side of the left pool wall, a second portion of the tin oxide electrode bricks on the right pool wall may protrude outward from an outer side of the right pool wall, and the lifting adjustment mechanism may be installed at a bottom portion of the first portion and the second portion of the tin oxide electrode bricks.

One or more embodiments of the present disclosure provide an electric heating method for a kiln of substrate glass based on the electric heating device provided in the present disclosure. The method may comprise: opening two feeding ports on the front pool wall and the liquid flow hole on the rear pool wall; installing the tin oxide electrode bricks at equal intervals on the left pool wall and the right pool wall, wherein a position of each of the tin oxide electrode bricks on the left pool wall corresponds to a position of one of the tin oxide electrode bricks on the right pool wall; installing the lifting adjusting mechanism at a bottom portion of the tin oxide electrode bricks; and installing the bottom-inserted molybdenum electrodes on the bottom pool wall.

### BRIEF DESCRIPTION OF THE DRAWINGS

The present disclosure is further described in terms of exemplary embodiments. These exemplary embodiments are described in detail with reference to the drawings. These embodiments are non-limiting exemplary embodiments, in which like reference numerals represent similar structures throughout the several views of the drawings, and wherein:

FIG. 1 is a front view of an exemplary electric heating device for a kiln of substrate glass according to some embodiments of the present disclosure;

FIG. 2 is a top view of an exemplary electric heating device for a kiln of substrate glass according to some embodiments of the present disclosure;

FIG. 3 is a side view of an exemplary electric heating device for a kiln of substrate glass according to some embodiments of the present disclosure;

FIG. 4 is a front view of another exemplary electric heating device for a kiln of substrate glass according to some embodiments of the present disclosure; and

FIG. 5 is a flowchart illustrating an exemplary process for adjusting an operation parameter of an electric heating device according to some embodiments of the present disclosure.

In the drawings: 1 represents tin oxide electrode bricks; 2 represents a left pool wall; 3 represents a rear pool wall; 4 represents burner nozzle bricks; 5 represents a side chest wall; 6 represents a front pool wall; 7 represents a liquid level line; 8 represents a feeding port; 9 represents a liquid flow hole; 10 represents bottom-inserted molybdenum electrodes; 11 represents a lifting adjustment mechanism; 12 represents a right pool wall; 13 represents a bottom pool wall; 14 represents a transmission mechanism; 15 represents a temperature detection device; 16 represents a liquid level detection device; 17 represents a controller; 18 represents a crown; and 19 represents a pressure detection device.

### DETAILED DESCRIPTION

In order to provide a clearer understanding of the technical solutions of the embodiments described in the present disclosure, a brief introduction to the drawings required in the description of the embodiments is given below. It is evident that the drawings described below are merely some examples or embodiments of the present disclosure, and for those skilled in the art, the present disclosure may be applied to other similar situations without exercising creative labor. Unless otherwise indicated or stated in the context, the same reference numerals in the drawings represent the same structures or operations.

It should be understood that the terms “system,” “device,” “unit,” and/or “module” used herein are ways for distinguishing different levels of components, elements, parts, or assemblies. However, if other terms can achieve the same purpose, they may be used as alternatives.

As indicated in the present disclosure and in the claims, the singular forms “a,” “an,” and “the” may be intended to include the plural forms as well, unless the context clearly indicates otherwise. In general, the terms “comprise,” “comprises,” and/or “comprising,” “include,” “includes,” and/or “including,” when used in this disclosure, specify the presence of stated features, integers, steps, operations, elements, and/or components, but do not preclude the presence or addition of one or more other features, integers, steps, operations, elements, components, and/or groups thereof.

Flowcharts are used in the present disclosure to illustrate the operations performed by the system according to the embodiments described herein. It should be understood that the operations may not necessarily be performed in the exact sequence depicted. Instead, the operations may be performed in reverse order or concurrently. Additionally, other operations may be added to these processes, or one or more operations may be removed.

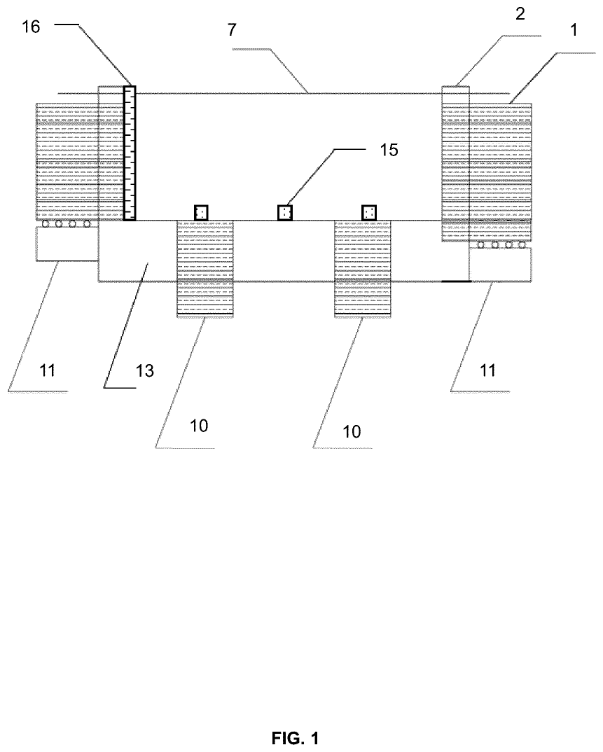

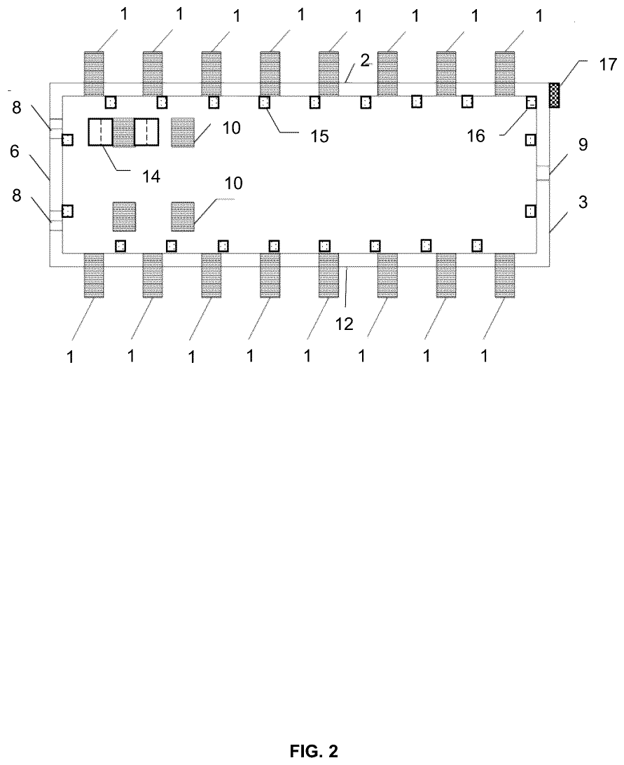

FIG. 1 is a front view of an exemplary electric heating device for a kiln of substrate glass according to some embodiments of the present disclosure. FIG. 2 is a top view of an exemplary electric heating device for a kiln of substrate glass according to some embodiments of the present disclosure.

In some embodiments, as shown in FIG. 1 and FIG. 2, the heating device for the kiln of substrate glass includes a bottom pool wall 13, a front pool wall 6, a rear pool wall 3, a left pool wall 2, a right pool wall 12, feeding ports 8, a liquid flow hole 9, tin oxide electrode bricks 1, bottom-inserted molybdenum electrodes 10, and a lifting adjustment mechanism 11. The front pool wall 6, the rear pool wall 3, the right pool wall 12, and the left pool wall 2 are disposed on the bottom pool wall 13. Two ends of the front pool wall 6 are connected to two ends of the rear pool wall 3 through the left pool wall 2 and the right pool wall 12, respectively. The feeding ports 8 are disposed on the front pool wall 6, and the liquid flow hole 9 is disposed on the rear pool wall 3. The tin oxide electrode bricks 1 are disposed on the left pool wall 2 and the right pool wall 12, and an interval between each two adjacent oxide electrode bricks 1 among the tin oxide electrode bricks 1 is equal. The bottom-inserted molybdenum electrodes 10 are disposed on the bottom pool wall 13. A first portion of the tin oxide electrode bricks 1 on the left pool wall 2 protrudes outward from an outer side of the left pool wall 2, and a second portion of the tin oxide electrode bricks 1 on the right pool wall 12 protrudes outward from an outer side of the right pool wall 12. The lifting adjustment mechanism 11 is installed at a bottom portion of a protruded portion (i.e., the first portion and the second portion) of the tin oxide electrode bricks 1.

The bottom pool wall 13 refers to a load-bearing structure at a bottom portion of the kiln to support the entire kiln and accommodate glass melt. In some embodiments, as shown in FIG. 2, the front pool wall 6, the rear pool wall 3, the left pool wall 2, and the right pool wall 12 are disposed on a front side, a rear side, a left side, and a right side of the bottom pool wall 13, respectively, thereby forming a semi-closed rectangular structure.

In some embodiments, the feeding ports 8 disposed on the front pool wall 6 include two feeding ports 8. The feeding ports 8 may be configured to feed a raw material into the kiln.

In some embodiments, the liquid flow hole 9 is disposed on the rear pool wall 3. The liquid flow hole 9 may be configured to flow out the melted glass melt from the kiln. In some embodiments, side-stacked tin oxide electrode bricks 1 are disposed on the left pool wall 2 and the right pool wall 12.

The tin oxide electrode bricks 1 refer to electrodes for energizing and heating the glass melt. In some embodiments, the lifting adjustment mechanism 11 is installed at the bottom portion of the tin oxide electrode bricks 1 (e.g., the first portion and the second portion of the tin oxide electrode bricks 1).

The lifting adjustment mechanism 11 refers to a device for adjusting a height of each of the tin oxide electrode bricks 1.

In some embodiments, the bottom-inserted molybdenum electrodes 10 are disposed on the bottom pool wall 13.

The bottom-inserted molybdenum electrodes 10 refer to electrodes for heating the glass melt from a bottom portion of the glass melt.

In some embodiments, a position of each of the tin oxide electrode bricks 1 on the left pool wall 2 corresponds to a position of one of the tin oxide electrode bricks 1 on the right pool wall 12.

In some embodiments, a distance between the bottom-inserted molybdenum electrodes 10 and an inner side of the front pool wall 6 may be within a range of 620 millimeters (mm) to 630 mm. For example, the distance between the bottom-inserted molybdenum electrodes 10 and the inner side of the front pool wall 6 may be within a range of 621 mm to 628 mm, a range of 624 mm to 629 mm, etc. A spacing between bottom-inserted molybdenum electrodes 10 disposed close to the left pool wall 2 and bottom-inserted molybdenum electrodes 10 disposed close to the right pool wall 12 may be within a range of 960 mm to 980 mm. For example, the spacing between the bottom-inserted molybdenum electrodes 10 disposed close to the left pool wall 2 and the bottom-inserted molybdenum electrodes 10 disposed close to the right pool wall 12 may be within a range of 962 mm to 970 mm, a range of 968 mm to 978 mm, etc. This arrangement can solve the problem that melting capacity of a pre-melting front zone of the kiln of substrate glass is insufficient.

In some embodiments, the bottom-inserted molybdenum electrodes 10 include four bottom-inserted molybdenum electrodes 10, and the four bottom-inserted molybdenum electrodes 10 are parallel to each other. For example, two of the four bottom-inserted molybdenum electrodes 10 are disposed close to the left pool wall 2, and another two of the four bottom-inserted molybdenum electrodes 10 are disposed close to the right pool wall 12.

In some embodiments, for each of the bottom-inserted molybdenum electrodes 10, a melting point of the bottom-inserted molybdenum electrode 10 is greater than 2420 degrees centigrade (° C.), a density of the bottom-inserted molybdenum electrode 10 is greater than 10.2 grams per cubic centimeter (g/cm³), and a surface current density of the bottom-inserted molybdenum electrode 10 is within a range of 0.7 to 1.0 amperes per square centimeter (A/cm²), thereby ensuring a relatively long operating life of the bottom-inserted molybdenum electrodes 10.

In some embodiments, the bottom-inserted molybdenum electrodes are molybdenum electrodes processed by multicomponent thermochemical treatment. For example, before the bottom-inserted molybdenum electrodes 10 are used, a high-temperature oxidation-resistant coating is prepared on a surface of a pure molybdenum electrode using the multicomponent thermochemical treatment. An outermost layer of the coating is a silicon dioxide (SiO₂) coating. For instance, after being processed by the multicomponent thermochemical treatment, a melting point of each of the tin oxide electrode bricks 1 (the tin oxide electrode brick 1) is greater than 1630° C., a density of the tin oxide electrode brick 1 is greater than 6.5 g/cm³, and a current density requirement of the tin oxide electrode brick 1 is less than 0.1 A/cm², thereby ensuring a relatively long operating life of the tin oxide electrode bricks 1.

In some embodiments, the tin oxide electrode bricks 1 disposed on the left pool wall 2 include eight tin oxide electrode bricks 1 with equal intervals, and the tin oxide electrode bricks 1 disposed on the right pool wall 12 include eight tin oxide electrode bricks 1 with equal intervals. For example, eight pairs of tin oxide electrode bricks 1 are disposed at corresponding positions on the left pool wall 2 and the right pool wall 12. A distance between each pair of tin oxide electrode bricks may be within a range of 2300 mm to 2320 mm. For example, the distance between each pair of tin oxide electrode bricks may be within a range of 2300 mm to 2310 mm, a range of 2310 mm to 2320 mm, etc., thereby ensuring that a voltage between each pair of tin oxide electrode bricks is less than 1100 volt (V). In some embodiments, a distance between two of the tin oxide electrode bricks 1 at corresponding positions on the left pool wall 2 and the right pool wall 12 is greater than two times a width of one of the tin oxide electrode bricks 1.

In some embodiments, the tin oxide electrode bricks 1 need to be covered by a normal glass liquid level to inhibit high temperature oxidation and volatilization of the electrodes. Thus, a liquid level height of the glass melt may be higher than 70 mm above a top portion of one of the tin oxide electrode bricks 1. For example, a distance between the top portion of one of the tin oxide electrode bricks 1 and a top portion of the left pool wall 2 is greater than 70 mm, and a distance between the top portion of one of the tin oxide electrode bricks 1 and a top portion of the right pool wall 12 is greater than 70 mm.

In order to address the problem of melting in the pre-melting zone of the kiln under large feeding amounts, some embodiments of the present disclosure provide two pairs of bottom-inserted molybdenum electrodes 10 in the pre-melting zone of the kiln. In some embodiments, the bottom-inserted molybdenum electrodes 10 are flush with an inside surface of the bottom pool wall 13. That is, an upper surface of the bottom-inserted molybdenum electrodes 10 is flush with the bottom pool wall 13, so as to improve the melting problem at the bottom portion of a material mountain.

According to some embodiments of the present disclosure, by determining a comprehensive thermal efficiency of the kiln, rationally arranging a side-pile tin oxide electrode structure, and designing the bottom-inserted molybdenum electrodes at the bottom portion of the kiln, the electric heating device for the kiln of substrate glass solves the problem of the insufficient melting capability in the pre-melting zone of the kiln of substrate glass caused by large feeding amounts. This provides a strong guarantee for efficient melting and stable convection of large-tonnage substrate glass batch materials.

In some embodiments, the electric heating device further includes a plurality of temperature detection devices 15, a pressure detection device 19, a liquid level detection device 16, and a controller 17.

A temperature detection device 15 refers to a detection device for capturing temperature. In some embodiments, the temperature detection device 15 may include a temperature sensor, e.g., a thermocouple, etc.

In some embodiments, the plurality of temperature detection devices are disposed on the front pool wall 6, the rear pool wall 3, the right pool wall 12, the left pool wall 2, and the bottom pool wall 13. For example, the plurality of temperature detection devices may be disposed at a plurality of preset points on the front pool wall 6, the rear pool wall 3, the right pool wall 12, the left pool wall 2, and the bottom pool wall 13. The preset points may be pre-determined manually.

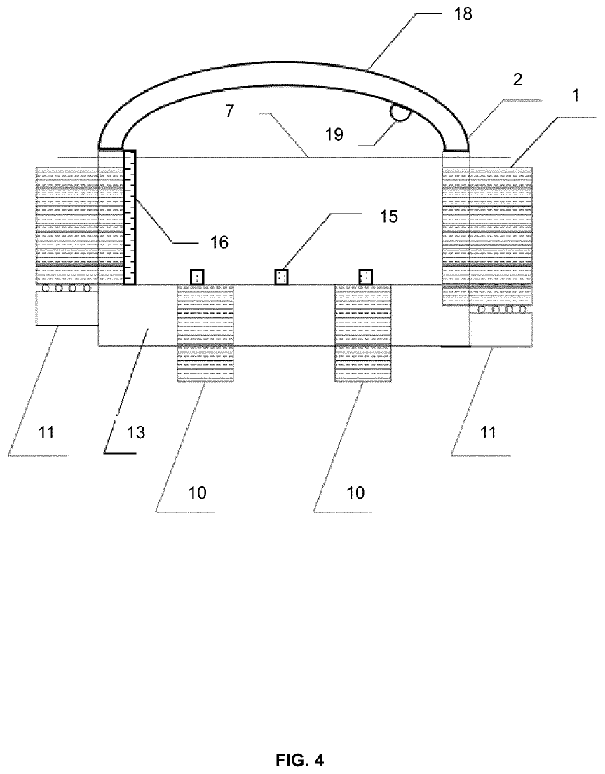

FIG. 4 is a front view of another exemplary electric heating device for a kiln of substrate glass according to some embodiments of the present disclosure.

In some embodiments, as shown in FIG. 4, the electric heating device may be a closed structure including a crown 18. The crown 18 refers to an arched structure at a top portion of the kiln of substrate glass to enclose an upper space of the kiln. In some embodiments, the plurality of temperature detection devices 15 are disposed on the crown 18.

The pressure detection device 19 refers to a device for detecting air pressure above the glass melt. In some embodiments, the pressure detection device 19 may include an air pressure sensor.

In some embodiments, one pressure detection device 19 may be disposed on a top potion of the crown 18.

The liquid level detection device 16 refers to a device for monitoring a liquid level height of the glass melt. For example, the liquid level detection device 16 may include a liquid level scale, an ultrasonic level meter, a laser range finder, or the like, or any combination thereof. The liquid level height refers to a height corresponding to a liquid level line 7 of the glass melt. In some embodiments, the liquid level detection device may be disposed on at least one of the front pool wall 6, the rear pool wall 3, the right pool wall 12, or the left pool wall 2.

The controller 17 refers to a structure for processing data and executing instructions. In some embodiments, the controller 17 may be located outside the electric heating device and communicate with each of the detection devices (e.g., the temperature detection devices 15, the pressure detection device 19, and the liquid level detection device 16). The controller 17 may be configured to control operation parameter(s) of each of the electrodes (e.g., the tin oxide electrode bricks 1, the bottom-inserted molybdenum electrodes 10) and burner nozzle bricks 4. A burner nozzle brick 4 refers to a device for heating by burning fuel gas.

In some embodiments, the controller 17 is configured to execute program instructions to perform one or more functions described in the present disclosure.

Merely by way of example, the controller 17 may include a central processing unit (CPU), an application-specific integrated circuit (ASIC), an application-specific instruction processor (ASIP), a graphics processor (GPU), or the like, or any combination thereof.

In some embodiments of the present disclosure, by disposing the temperature detection devices, the pressure detection device, and the liquid level detection device on the electric heating device, temperatures, pressure conditions, and liquid level heights inside the kiln can be monitored in real-time, which provides critical data support for the safe operation and process control of the kiln. By disposing with the controller, the electrodes can be adjusted based on the collected data.

In some embodiments, as shown in FIG. 2, the electric heating device further comprises a transmission mechanism 14, and the bottom-inserted molybdenum electrodes 10 are disposed on the transmission mechanism 14. The transmission mechanism 14 is configured to adjust positions of the bottom-inserted molybdenum electrodes 10. The transmission mechanism 14 refers to a mechanism for adjusting position(s) of component(s) through a conveyor belt. In some embodiments, an overall position of the transmission mechanism 14 remains unchanged, and the bottom-inserted molybdenum electrodes 10 are fixed on the transmission mechanism 14. The transmission mechanism 14 changes the positions of the bottom-inserted molybdenum electrodes 10 in a horizontal direction by stretching the conveyor belt on two sides of the transmission mechanism 14.

In some embodiments, the transmission mechanism 14 is disposed on the bottom pool wall 13, and an upper surface of the transmission mechanism 14 is parallel to the bottom pool wall 13.

In some embodiments, the transmission mechanism 14 is made of a high-temperature resistant material. For example, the high-temperature resistant material may include a heat-resistant alloy, a heat-resistant steel, or the like, or any combination thereof.

In some embodiments of the present disclosure, by disposing the transmission mechanism, the positions of the bottom-inserted molybdenum electrodes can be adjusted, which can heat certain points more fully in a targeted manner and facilitate thorough melting of the glass, thereby improving production efficiency.

In some embodiments, as shown in a right side of FIG. 1, at least a portion of the tin oxide electrode bricks 1 are disposed below the bottom pool wall 13. The lifting adjustment mechanism 11 is configured to lift a height of each of the tin oxide electrode bricks 1.

In some embodiments of the present disclosure, the lifting adjustment mechanism is disposed outside the pool wall 1 and configured to lift the outside (or protruded) portion (e.g., the first portion and the second portion) of the tin oxide electrode bricks 1 to lift the tin oxide electrode bricks, thereby increasing a contact area between the tin oxide electrode bricks and the glass melt, and improving heating efficiency.

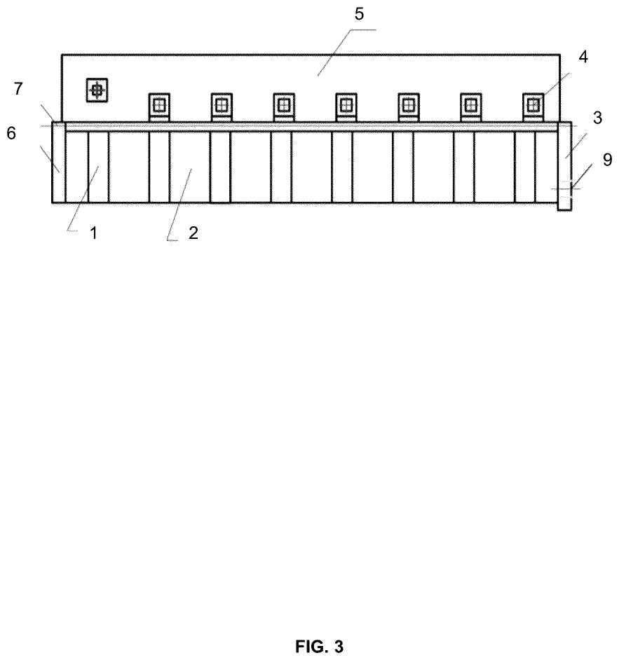

FIG. 3 is a side view of an exemplary electric heating device for a kiln of substrate glass according to some embodiments of the present disclosure.

Some embodiments of the present disclosure focus on an arrangement of electrodes. A structure in FIG. 3, together with a side chest wall 5 and the burner nozzle bricks 4, highlights that the kiln is a gas-electric hybrid kiln. Since molybdenum electrodes are typically used in a reducing atmosphere, and are easily oxidized to form molybdenum oxide (MoO₃) in an oxidizing atmosphere and volatilize, a high-temperature anti-oxidation coating is prepared on a surface of the molybdenum electrodes by multicomponent thermochemical treatment when the molybdenum electrodes are used. This prevents severe oxidation and volatilization when the glass melt does not cover the molybdenum electrodes during a liquid rising process. The high-temperature oxidation-resistant coating must be prepared on the molybdenum electrodes selected for the structure (i.e., the structure of the electric heating device shown in FIG. 3) before use. An outermost surface of the coating is a SiO₂ coating.

Some embodiments of the present disclosure provide an electric heating method for a kiln of substrate glass. The method may comprise the following operations: opening two feeding ports 8 on the front pool wall 6 and the liquid flow hole 9 on the rear pool wall; installing the tin oxide electrode bricks 1 at equal intervals on the left pool wall 2 and the right pool wall 12, wherein a position of each of the tin oxide electrode bricks 1 on the left pool wall 2 corresponds to a position of one of the tin oxide electrode bricks 1 on the right pool wall 12; installing the lifting adjusting mechanism 11 at a bottom portion of the tin oxide electrode bricks 1; and installing the bottom-inserted molybdenum electrodes 10 on the bottom pool wall 13.

For instance, as shown in FIG. 2, eight tin oxide electrode bricks 1 may be installed at equal intervals on the left pool wall 2, and eight tin oxide electrode bricks 1 may be installed at equal intervals at corresponding positions on the right pool wall 12. A distance between two tin oxide electrode bricks 1 at corresponding positions on the left pool wall 2 and the right pool wall 12 may be in a range of 2300 mm to 2320 mm. In some embodiments, the lifting adjustment mechanism 11 may be installed at the bottom portion of each of the tin oxide electrode bricks 1.

In some embodiments of the present disclosure, by installing the various structures of the electric heating device in the manner described above, each zone in the kiln can be sufficiently heated, thereby improving a melting capacity of a front zone of the kiln, and enhancing production efficiency.

In some embodiments, before the installation of the bottom-inserted molybdenum electrodes 10, the bottom-inserted molybdenum electrodes 10 may be processed by multicomponent thermochemical treatment to form a high-temperature oxidation-resistant coating on the surface of each of the bottom-inserted molybdenum electrodes 10.

In some embodiments of the present disclosure, by performing the multicomponent thermochemical treatment on the bottom-inserted molybdenum electrodes to form the high-temperature oxidation-resistant coating on the surface of each of the bottom-inserted molybdenum electrodes 10, the problem that the molybdenum electrode cannot be used in the oxidizing atmosphere is solved.

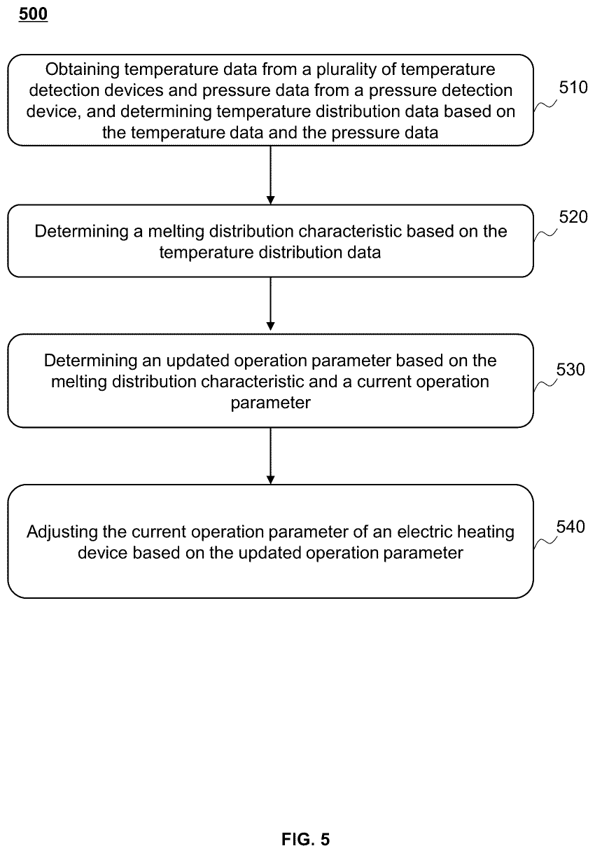

FIG. 5 is a flowchart illustrating an exemplary process 500 for adjusting an operation parameter of an electric heating device according to some embodiments of the present disclosure.

In some embodiments, the electric heating method for the kiln of substrate glass further comprises: obtaining temperature data from a plurality of temperature detection devices and pressure data from a pressure detection device; determining temperature distribution data based on the temperature data and the pressure data; determining a melting distribution characteristic based on the temperature distribution data; determining an updated operation parameter based on the melting distribution characteristic and a current operation parameter; and adjusting the current operation parameter of the electric heating device based on the updated operation parameter.

In some embodiments, the process 500 may be performed by a controller (e.g., the controller 17). As shown in FIG. 5, the process 500 includes the following operations.

In 510, temperature data may be obtained from a plurality of temperature detection devices, pressure data may be obtained from a pressure detection device, and temperature distribution data may be determined based on the temperature data and the pressure data.

The temperature data refers to data that reflects a temperature of glass melt.

The pressure data refers to data that reflects an air pressure above the glass melt.

The temperature distribution data refers to a collection of temperature data of a plurality of preset points and the pressure data. In some embodiments, the temperature distribution data may include the temperature data of a surface of the glass melt and the plurality of preset points within the glass melt and the pressure data. More descriptions regarding the preset points may be found elsewhere in the present disclosure. See, e.g., FIGS. 1 and 2, and relevant descriptions thereof.

In some embodiments, the controller may determine the temperature distribution data in multiple manners based on the temperature data and the pressure data. For example, the controller may construct a first feature vector based on the temperature data and the pressure data. The controller may match the first feature vector with first reference vectors in a first vector database, and designate a first reference vector with a highest similarity with the first feature vector as a first target vector. The controller may further determine a first label corresponding to the first target vector as the temperature distribution data. The first similarity may be determined based on a cosine distance, an Euclidean distance, etc.

In some embodiments, the first vector database includes a plurality of first reference vectors and a label corresponding to each of the plurality of first reference vectors. The first reference vectors may be constructed based on historical temperature data and historical pressure data actually collected, and the corresponding labels may be actual temperature distribution data corresponding to the historical temperature data and the historical pressure data.

In 520, a melting distribution characteristic may be determined based on the temperature distribution data.

The melting distribution characteristic refers to a data collection reflecting a melting degree of the glass melt in each zone. In some embodiments, the melting distribution characteristic may include a melting value for each zone. The melting value for each zone may be represented by a percentage of a melted portion of the zone. Each zone may include a plurality of preset points. For example, if a zone is a rectangle, the plurality of preset points of the zone may be vertices and a center point of the rectangle. The melting value refers to a value reflecting the melting degree of the zone.

In some embodiments, the controller may determine the melting distribution characteristic in multiple manners. For example, the controller may obtain sub-temperature distribution data for each zone by grouping the temperature distribution data based on the preset points corresponding to each zone. The controller may determine the melting value of the zone corresponding to each sub-temperature distribution data by querying a pre-established first preset table. The controller may generate the melting distribution characteristic by sorting, based on each zone and the corresponding melting value, the melting value corresponding to each zone according to a certain order (e.g., a number sequence of the zones). The first preset table may be constructed based on actual sampling data and may include different sub-temperature distribution data and their corresponding melting values.

In 530, an updated operation parameter may be determined based on the melting distribution characteristic and a current operation parameter.

The current operation parameter refers to a relevant operation parameter of the electric heating device corresponding to a time when the controller collects data. For example, the current operation parameter may include current powers of electrodes (e.g., the tin oxide electrode bricks 1, the bottom-inserted molybdenum electrodes 10), a burner volume of the burner nozzle bricks 4, etc. The burner volume refers to an amount of gas used per unit of time by the burner nozzle bricks 4.

In some embodiments, a current sensor, a voltage sensor, etc., may be disposed on a circuit connecting the electrodes, and a gas meter may be disposed at a gas pipe connecting the burner nozzle bricks 4. The controller may determine the power of each electrode and the burner volume of the burner nozzle bricks 4 based on readings of the current sensor, the voltage sensor, and the gas meter.

The updated operation parameter refers to a new operation parameter of the electric heating device that the current operation parameter needs to be adjusted to. For example, the updated operation parameter may include an adjusted power of each of the electrodes (e.g., tin oxide electrode bricks 1 and the bottom-inserted molybdenum electrodes 10), an adjusted burner volume of the burner nozzle bricks 4, etc.

In some embodiments, the controller may determine the updated operation parameter in multiple manners based on the melting distribution characteristic and the current operation parameter. For example, the controller may determine the updated operation parameter based on the melting distribution characteristic and the current operation parameter through an operation parameter model.

The operation parameter model refers to a model for determining the updated operation parameter. In some embodiments, the operation parameter model may be a machine learning model. For example, the operation parameter model may include a neural networks (NN) model, a deep neural networks (DNN) model, or the like, or any combination thereof. In some embodiments, an input of the operation parameter model may include the melting distribution characteristic and the current operation parameter, and an output of the operation parameter model may include the updated operation parameter.

In some embodiments, the controller may train the operation parameter model based on a plurality of sets of first training samples with first labels. In some embodiments, the controller may select, from historical records, records in each of which a melting requirement is satisfied after a single adjustment of the operation parameter as the first training samples. Each of the first training samples may include a sample melting distribution characteristic before the adjustment of the operation parameters and a sample current operation parameter. A first label corresponding to the first training sample may include an adjusted operation parameter. The melting requirement being satisfied means that a count of target zones exceeds a preset threshold, wherein a melting value of each of the target zones reaches 100% within a preset time.

In some embodiments, the controller may input a large number of first training samples into an initial operation parameter model, construct a loss function based on an output of the initial operation parameter model and the labels of the first training samples, and iteratively update the initial operation parameter model based on the loss function. When a value of the loss function satisfies an iteration completion condition, the training is completed and a trained operation parameter model is obtained. The iteration completion condition may include that the loss function converges, a count of iterations reaches a threshold, etc.

In some embodiments, the controller may determine updated positions of the bottom-inserted molybdenum electrodes 10 based on the melting distribution characteristic, and determine the updated operation parameter based on the updated positions, the melting distribution characteristic, and the current operation parameter.

The updated positions refer to new positions of the bottom-inserted molybdenum electrodes 10 that need to be adjusted to.

In some embodiments, the controller may determine the updated positions in multiple manners based on melting conditions above different positions in the front zone of the kiln. For example, the controller may obtain melting conditions of all zones above the conveyor belt of the transmission mechanism 14 based on the melting distribution characteristic. The controller may divide the zones above the conveyor belt into a plurality of vertical columns in a horizontal direction, as indicated by the dashed lines in FIG. 2. The controller may obtain a comprehensive melting value by performing a weighted summation of the melting values of zones at different heights within a same vertical column. Further, the controller may determine a position on the conveyor belt corresponding to the column with a lowest comprehensive melting value as the updated position. A weight for the weighted summation relates to a distance between the bottom-inserted molybdenum electrodes 10 and the bottom pool wall 13 of the front zone of the kiln. For example, the closer a zone in which the bottom-inserted molybdenum electrodes 10 are to the bottom pool wall 13, the greater the weight corresponding to the zone.

In some embodiments, the controller may add the updated positions into the input of the operation parameter model. In some embodiments, when the updated positions are added to the input of the operation parameter model, sample updated positions may be added to the first training samples. The manner of obtaining the first training samples including the sample updated positions and the corresponding first labels, as well as the training process, is similar to the relevant descriptions above.

In some embodiments of the present disclosure, the updated position of the bottom-inserted molybdenum electrodes can be determined based on the melting distribution characteristic, and then the updated operation parameter can be determined, which allows the bottom-inserted molybdenum electrodes to be adjusted to more reasonable positions. This optimizes the heating distribution and the updated operation parameter, thereby improving the heating performance of the electric heating device.

In some embodiments, the controller may determine the updated operation parameter based on melting data of the glass melt flowing out of a liquid flow hole, the melting distribution characteristic, and the current operation parameter.

The melting data refers to data reflecting a completion status of melting of the glass melt. For example, the melting data may include data such as an image, a temperature, a flow rate, a viscosity, etc., of the melted glass melt.

In some embodiments, the controller may obtain the melting data by observing or experimenting, through different devices, on outflowing glass melt. For example, the controller may capture the image of the glass melt using a camera, measure the temperature of the glass melt using a temperature detection device, determine the flow rate of the glass melt using a flowmeter, and determine the viscosity of the glass melt through a viscosity experiment.

In some embodiments, the controller may determine the updated operation parameter in multiple manners based on the melting data of the glass melt flowing out of the liquid flow hole, the melting distribution characteristic, and the current operation parameter. In some embodiments, the melting data may be used as the input of the operation parameter model. The operation parameter model may include a feature extraction layer and a parameter determination layer. The feature extraction layer may be configured to extract a melting completion characteristic based on the melting data, and then input the melting completion characteristic, the melting distribution characteristic, and the current operation parameter into the parameter determination layer to obtain the updated operation parameter. The melting completion characteristic refers to data reflecting a characteristic of the melted glass melt. The melting completion characteristic may be a matrix, etc., output by the feature extraction layer.

In some embodiments, the feature extraction layer may be a convolutional neural network (CNN) model, and the parameter determination layer may include a neural network model, a deep neural network model, or the like, or any combination thereof. The feature extraction layer may be obtained by training feature samples with feature labels. The feature samples may be sample melting data in the historical records, and the feature labels may be historically actual melting completion characteristics corresponding to the feature samples. The feature labels may be automatically labeled by the controller based on the historical records.

In some embodiments, the operation parameter model including the feature extraction layer and the parameter determination layer may be obtained by joint training of the feature extraction layer and the parameter determination layer. In some embodiments, second training samples of the joint training may include sample melting data, sample melting distribution characteristics, and sample current work parameters, and second labels may include operation parameters that correspond to the second training samples and satisfy the melting requirement. The second labels may be determined in a manner similar to the first labels. The controller may input the sample melting data into the feature extraction layer, and obtain output melting completion characteristics. The output melting completion characteristics, the sample melting distribution characteristics, and the sample current operation parameters may be then input into the parameter determination layer, and output updated operation parameters may be generated. A loss function may be constructed based on the second labels and the output updated operation parameter output by the parameter determination layer, and parameters of the feature extraction layer and the parameter determination layer are simultaneously updated based on the loss function. Through the updating of the parameters, the trained feature extraction layer and the trained parameter determination layer may be obtained.

In some embodiments of the present disclosure, by incorporating the melting data of the glass melt flowing out of the liquid flow hole to determine the updated operation parameter, the accuracy of the assessment of a melting effect can be improved, thereby improving the degree of compliance between the determined updated operation parameter and actual conditions.

In 540, the current operation parameter of the electric heating device may be adjusted based on the updated operation parameter.

In some embodiments, based on the updated operation parameter, the controller may adjust the power of each of the electrodes by adjusting a current or a voltage of a power supply, and adjusting the burner volume of the burner nozzle bricks through a gas valve.

In some embodiments of the present disclosure, by determining the temperature distribution data and determining the melting distribution characteristic based on the temperature distribution data, the updated operation parameter of the electric heating device can be determined. In this case, the current operation parameter of the electric heating device can be adjusted and optimized according to actual situations of the melting process, which improves heating efficiency and precision, thereby enhancing production efficiency and product quality.

In some embodiments, the controller may obtain temperature data of the tin oxide electrode bricks from a plurality of temperature detection devices, and obtain a liquid level height from a liquid level detection device; determine a target height of each of the tin oxide electrode bricks based on the temperature data and the liquid level height; and control the lifting adjustment mechanism to lift the tin oxide electrode bricks to the target height.

The target height refers to a height of each of the tin oxide electrode bricks 1 that needs to be adjusted to.

In some embodiments, the controller may determine the target height of the tin oxide electrode bricks in multiple manners based on the temperature data and the liquid level height. For example, the controller may construct a second feature vector based on the temperature data and the liquid level height, match the second feature vector with second reference vectors in a second vector database, and designate a second reference vector with a second highest similarity with the second feature vector as a second target vector. A second label corresponding to the second target vector may be determined as the target height of the tin oxide electrode bricks 1. The second similarity may be determined based on a cosine distance, an Euclidean distance, etc.

The second vector database includes the second reference vectors and second labels corresponding to the second reference vectors. Each of the second reference vectors may include actual temperature data and a liquid level height in historical records, and the second label corresponding to the second reference vector may be a height of the tin oxide electrode bricks 1 in the historical records when the heating effect is relatively good. The relatively good heating effect refers to a heating rate being above a rate threshold.

In some embodiments, the target height may relate to the melting distribution characteristic. For example, the controller may determine a peripheral melting value and an average melting value based on the melting distribution characteristic, and the target height may relate to a difference between the peripheral melting value and the average melting value. For instance, if the peripheral melting value is smaller than the average melting value, the greater the difference is, the target height is more likely to be increased in order to raise the melting value of a surrounding zone. Conversely, if the peripheral melting value is greater than the average melting value, the greater the difference is, the target height is more likely to be decreased. The peripheral melting value refers to a value reflecting a melting degree of a zone surrounding the tin oxide electrode bricks 1. The peripheral melting value may be obtained by a weighted average of melting values of a plurality of zones. The closer a zone is to a target tin oxide electrode brick, the greater the weight of the zone. The average melting value refers to a value reflecting a melting degree of all zones. The average melting value may be represented by an average of the melting values of all zones.

Merely by way of example, the controller may construct a third feature vector based on the temperature data, the liquid level height, and the difference between the peripheral melting value and the average melting value, match the third feature vector with third reference vectors in a third vector database, and designate a third reference vector with a third highest similarity with the third feature vector as a third target vector. A third label corresponding to the third target vector may be determined as the target height of the tin oxide electrode bricks 1.

The third vector database includes the third reference vectors and third labels corresponding to the third reference vectors. The third reference vectors and the corresponding third labels thereof may be determined in a similar manner to the second reference vectors and the corresponding second labels, which are not repeated herein.

In some embodiments of the present disclosure, by relating the target height of the tin oxide electrode bricks to the melting distribution characteristic, the tin oxide electrode bricks can heat the glass melt more efficiently and uniformly, thereby improving production efficiency.

In some embodiments of the present disclosure, by determining the target height based on the temperature data and the liquid level height and adjusting the tin oxide electrode bricks to the target height, the height of the electrode bricks can be lowered when the temperature is high to reduce high-temperature oxidation and volatilization. When the temperature is lower, the height of the tin oxide electrode bricks can be raised to increase the contact area between the tin oxide electrode bricks and the glass melt, thereby improving the heating efficiency.

It should be noted that the above descriptions about the process 500 are only for illustration and description, and do not limit the scope of application of the present disclosure. For those skilled in the art, various modifications and changes may be made to the process 500 under the guidance of the present disclosure. However, such modifications and changes are still within the scope of the present disclosure.

In some embodiments of the present disclosure, as shown in Table 1, different combinations of gas-to-electricity ratios may be employed to determine a comprehensive thermal efficiency of the kiln, thereby ensuring the comprehensive thermal efficiency of the kiln.

TABLE 1
Comprehensive Thermal Efficiency of Kiln at Different Gas-to-Electricity Ratios

| | | | | | | | Energy | |
|---|---|---|---|---|---|---|---|---|
| Power of | Power of | Electrical | | Calorific | | | consumption | Kiln |
| tin oxide | molybdenum | calorific | Burner | value of | Total | Drainage | per unit of | thermal |
| electrode | electrode | value | volume | gas | calories | volume | glass melted | efficiency |
| (KW) | (KW) | (kcal/kj) | (m³/h) | (kcal/m³) | (kcal) | (kg/h) | (KJ) | (%) |
| 1000 | 300 | 860 | 100 | 8100 | 1928000 | 1250 | 2283 | 39% |
| 1100 | 320 | 860 | 110 | 8100 | 2112200 | 1250 | 2283 | 36% |
| 1200 | 360 | 860 | 120 | 8100 | 2313600 | 1250 | 2283 | 33% |
| 1250 | 380 | 860 | 130 | 8100 | 2454800 | 1250 | 2283 | 31% |

Some embodiments of the present disclosure provide a novel electric heating structure for a kiln of substrate glass. Firstly, simulation analysis is performed to address the problems of insufficient melting and unstable convection in the pre-melting zone of the kiln under high-tonnage and large-feed conditions for high-generation substrate glass. Then, by designing different combinations of electricity and gas usage, the comprehensive thermal efficiency of the kiln is determined to be between 30% and 40%. The side-stack tin oxide electrode bricks are reasonably arranged, and the bottom-inserted molybdenum electrodes are scientifically and reasonably designed at the bottom portion of the pre-melting zone of the kiln. Moreover, the high-temperature anti-oxidation coating is prepared on the surface of each of the molybdenum electrodes using the multicomponent thermochemical treatment, solving the challenge of using molybdenum electrodes in the oxidizing atmosphere. Current density safety limits of the tin oxide electrode bricks and the molybdenum electrodes are also designed to ensure the long-term stable operation of the electrodes. This solves the problem of insufficient melting capacity in the pre-melting zone of the kiln caused by large feeding amounts, and provides a strong guarantee for efficient melting and stable convection of substrate glass batch materials.

As is known from technical knowledge, the present disclosure can be realized by other embodiments without departing from the principles or essential features of the present disclosure. Therefore, the disclosed embodiments above are illustrative in all aspects and not exclusive. All modifications within the scope of or equivalent to the present disclosure are included in the present disclosure.

Having thus described the basic concepts, it may be rather apparent to those skilled in the art after reading this detailed disclosure that the foregoing detailed disclosure is intended to be presented by way of example only and is not limiting. Various alterations, improvements, and modifications may occur and are intended to those skilled in the art, though not expressly stated herein. These alterations, improvements, and modifications are intended to be suggested by this disclosure, and are within the spirit and scope of the exemplary embodiments of this disclosure.

Moreover, certain terminology has been used to describe embodiments of the present disclosure. For example, the terms “one embodiment,” “an embodiment,” and/or “some embodiments” mean that a particular feature, structure, or feature described in connection with the embodiment is included in at least one embodiment of the present disclosure. Therefore, it is emphasized and should be appreciated that two or more references to “an embodiment” or “one embodiment” or “an alternative embodiment” in various portions of this disclosure are not necessarily all referring to the same embodiment. Furthermore, the particular features, structures, or features may be combined as suitable in one or more embodiments of the present disclosure.

Furthermore, the recited order of processing elements or sequences, or the use of numbers, letters, or other designations therefore, is not intended to limit the claimed processes and methods to any order except as may be specified in the claims. Although the above disclosure discusses through various examples what is currently considered to be a variety of useful embodiments of the disclosure, it is to be understood that such detail is solely for that purpose, and that the appended claims are not limited to the disclosed embodiments, but, on the contrary, are intended to cover modifications and equivalent arrangements that are within the spirit and scope of the disclosed embodiments. For example, although the implementation of various components described above may be embodied in a hardware device, it may also be implemented as a software only solution, e.g., an installation on an existing server or mobile device.

It should be appreciated that in the foregoing description of embodiments of the present disclosure, various features are sometimes grouped together in a single embodiment, figure, or description thereof for the purpose of streamlining the disclosure aiding in the understanding of one or more of the various inventive embodiments. This way of disclosure, however, is not to be interpreted as reflecting an intention that the claimed subject matter requires more features than are expressly recited in each claim. Rather, inventive embodiments lie in less than all features of a single foregoing disclosed embodiment.

In some embodiments, the numbers expressing quantities or properties used to describe and claim certain embodiments of the present disclosure are to be understood as being modified in some instances by the term “about,” “approximate,” or “substantially.” For example, “about,” “approximate,” or “substantially” may indicate ±20% variation of the value it describes, unless otherwise stated. Accordingly, in some embodiments, the numerical parameter set forth in the written description and attached claims are approximations that may vary depending upon the desired properties sought to be obtained by a particular embodiment. In some embodiments, the numerical parameter should be construed in light of the count of reported significant digits and by applying ordinary rounding techniques. Notwithstanding that the numerical ranges and parameter setting forth the broad scope of some embodiments of the present disclosure are approximations, the numerical values set forth in the specific examples are reported as precisely as practicable.

Each of the patents, patent applications, publications of patent applications, and other material, such as articles, books, specifications, publications, documents, things, and/or the like, referenced herein is hereby incorporated herein by this reference in its entirety for all purposes, excepting any prosecution file history associated with same, any of same that is inconsistent with or in conflict with the present document, or any of same that may have a limiting effect as to the broadest scope of the claims now or later associated with the present document. By way of example, should there be any inconsistency or conflict between the description, definition, and/or the use of a term associated with any of the incorporated material and that associated with the present document, the description, definition, and/or the use of the term in the present document shall prevail.

In closing, it is to be understood that the embodiments of the present disclosure disclosed herein are illustrating of the principles of the embodiments of the present disclosure. Other modifications that may be employed may be within the scope of the present disclosure. Thus, by way of example, but not of limitation, alternative configurations of the embodiments of the present disclosure may be utilized in accordance with the teachings herein. Accordingly, embodiments of the present disclosure are not limited to that precisely as shown and described.

What is claimed is:

1. An electric heating device for a kiln of substrate glass, wherein the electric heating device comprises a bottom pool wall, a front pool wall, a rear pool wall, a left pool wall, a right pool wall, feeding ports, a liquid flow hole, tin oxide electrode bricks, bottom-inserted molybdenum electrodes, and a lifting adjustment mechanism, wherein the front pool wall, the rear pool wall, the right pool wall, and the left pool wall are disposed on the bottom pool wall,
two ends of the front pool wall are connected to two ends of the rear pool wall through the left pool wall and the right pool wall, respectively,
the feeding ports are disposed on the front pool wall,
the liquid flow hole is disposed on the rear pool wall,
the tin oxide electrode bricks are disposed on the left pool wall and the right pool wall, an interval between each two adjacent oxide electrode bricks among the tin oxide electrode bricks being equal, and
the bottom-inserted molybdenum electrodes are disposed on the bottom pool wall, wherein
a first portion of the tin oxide electrode bricks on the left pool wall protrudes outward from an outer side of the left pool wall, a second portion of the tin oxide electrode bricks on the right pool wall protrudes outward from an outer side of the right pool wall, and the lifting adjustment mechanism is installed at a bottom portion of the first portion and the second portion of the tin oxide electrode bricks.

2. The electric heating device of claim 1, wherein the feeding ports disposed on the front pool wall include two feeding ports.

3. The electric heating device of claim 1, wherein
the tin oxide electrode bricks disposed on the left pool wall include eight tin oxide electrode bricks with equal intervals, and
the tin oxide electrode bricks disposed on the right pool wall include eight tin oxide electrode bricks with equal intervals.

4. The electric heating device of claim 1, wherein a position of each of the tin oxide electrode bricks on the left pool wall corresponds to a position of one of the tin oxide electrode bricks on the right pool wall.

5. The electric heating device of claim 4, wherein a distance between two of the tin oxide electrode bricks at corresponding positions on the left pool wall and the right pool wall is greater than two times of a width of one of the tin oxide electrode bricks.

6. The electric heating device of claim 1, wherein the bottom-inserted molybdenum electrodes include four bottom-inserted molybdenum electrodes, and the four bottom-inserted molybdenum electrodes are parallel to each other.

7. The electric heating device of claim 6, wherein two of the four the bottom-inserted molybdenum electrodes are disposed close to the left pool wall, and another two of the four bottom-inserted molybdenum electrodes are disposed close to the right pool wall.

8. The electric heating device of claim 1, wherein a distance between a top portion of one of the tin oxide electrode bricks and a top portion of the left pool wall is greater than 70 millimeters, and a distance between the top portion of the tin oxide electrode brick and a top portion of the right pool wall is greater than 70 millimeters.

9. The electric heating device of claim 1, wherein the bottom-inserted molybdenum electrodes are flush with an inner surface of the bottom pool wall.

10. The electric heating device of claim 1, wherein the bottom-inserted molybdenum electrodes are molybdenum electrodes processed by multicomponent thermochemical treatment.

11. The electric heating device of claim 1, further comprising:
a plurality of temperature detection devices, a pressure detection device, a liquid level detection device, and a controller, wherein
the plurality of temperature detection devices are disposed on the front pool wall, the rear pool wall, the right pool wall, the left pool wall, and the bottom pool wall.

12. The electric heating device of claim 1, further comprising:
a transmission mechanism, wherein
the bottom-inserted molybdenum electrodes are disposed on the transmission mechanism, and the transmission mechanism is configured to adjust positions of the bottom-inserted molybdenum electrodes.

13. The electric heating device of claim 1, wherein
at least a portion of the tin oxide electrode bricks are located below the bottom pool wall; and
the lifting adjustment mechanism is configured to lift a height of each of the tin oxide electrode bricks.

14. An electric heating method for a kiln of substrate glass based on the electric heating device of claim 1, comprising:
opening two feeding ports on the front pool wall and the liquid flow hole on the rear pool wall;
installing the tin oxide electrode bricks at equal intervals on the left pool wall and the right pool wall, wherein a position of each of the tin oxide electrode bricks on the left pool wall corresponds to a position of one of the tin oxide electrode bricks on the right pool wall;
installing the lifting adjusting mechanism at a bottom portion of the tin oxide electrode bricks; and
installing the bottom-inserted molybdenum electrodes on the bottom pool wall.

15. The method of claim 14, wherein before installing the bottom-inserted molybdenum electrodes on the bottom pool wall, the bottom-inserted molybdenum electrodes are processed by multicomponent thermochemical treatment, so as to form a high-temperature antioxidant coating on a surface of each of the bottom-inserted molybdenum electrodes.

16. The method of claim 14, further comprising:
obtaining temperature data from a plurality of temperature detection devices and pressure data from a pressure detection device;
determining temperature distribution data based on the temperature data and the pressure data;
determining a melting distribution characteristic based on the temperature distribution data;
determining an updated operation parameter based on the melting distribution characteristic and a current operation parameter; and
adjusting the current operation parameter of the electric heating device based on the updated operation parameter.

17. The method of claim 16, wherein the determining an updated operation parameter based on the melting distribution characteristic and a current operation parameter includes:
determining updated positions of the bottom-inserted molybdenum electrodes based on the melting distribution characteristic; and
determining the updated operation parameter based on the updated locations, the melting distribution characteristic, and the current operation parameter.

18. The method of claim 16, wherein the determining the updated operation parameter based on the updated locations, the melting distribution characteristic, and the current operation parameter includes:
determining the updated operation parameter based on melting data of glass melt flowing out from the liquid flow hole, the melting distribution characteristic, and the current operation parameter.

19. The method of claim 14, further comprising:
obtaining temperature data of the tin oxide electrode bricks from a plurality of temperature detection devices and a liquid level height from a liquid level detection device;
determining a target height of each of the tin oxide electrode bricks based on the temperature data and the liquid level height; and
controlling the lifting adjustment mechanism to lift the tin oxide electrode bricks to the target height.

20. The method of claim 19, wherein the target height relates to a melting distribution characteristic.
